(19) United States
(12) Patent Application Publication
(10) Pub. No.: US 2024/0261668 A1
(43) Pub. Date: Aug. 8, 2024

(54) ROULETTE VISUAL DISPLAY FOR GAMING SYSTEMS

(71) Applicant: Interblock d.o.o., MENGES (SI)

(72) Inventor: Rok Kokoravec, Grgar (SI)

(21) Appl. No.: 18/603,990

(22) Filed: Mar. 13, 2024

Related U.S. Application Data
(63) Continuation-in-part of application No. 18/319,238, filed on May 17, 2023.
(60) Provisional application No. 63/483,246, filed on Feb. 3, 2023.

(51) Int. Cl. A63F 5/00; A63F 11/00

(52) U.S. Cl. CPC A63F 5/00; A63F 11/0051; A63F 2011/0058; A63F 2011/0072

(57) ABSTRACT

A roulette wheel system and method of using are disclosed. A roulette wheel may include a rotatable rim, a controller, and an optical display system. The optical display system may be configured to provide a plurality of lighting effects visible on a top surface of the rotatable rim. The controller may provide signal content to the optical display system to produce a lighting effect corresponding to current gaming information. Lighting effects may indicate simulating rotation of numbers or symbols, provide real-time game information, track a position of a roulette ball, respond to various gaming events, or promote interest and excitement towards the game.

### CROSS-REFERENCE TO RELATED APPLICATIONS

The present application is a continuation-in-part of U.S. patent Application No. 18/319,238, filed May 17, 2023, and claims priority to U.S. Provisional Application No. 63/483,246, filed Feb. 3, 2023, each of which are incorporated herein by reference.

### TECHNICAL FIELD

The present disclosure relates to gaming apparatus and more particularly to roulette gaming apparatus or systems and methods for using the same.

### BACKGROUND

Roulette is a popular game played in gaming establishments. In mechanical versions of the game (versus video generated), a roulette ball is launched into a stationary rim having a single angled annular track encircling a spinning roulette wheel. The spinning wheel rotates in the opposite direction of the rotating roulette ball. The roulette ball rotates around the annular track until friction between the roulette ball and the annular track and gravity cause the ball to lose momentum. Upon losing sufficient momentum, the roulette ball exits the annular track and falls on to the roulette wheel.

Between the track and the roulette wheel, the roulette ball may engage with one or more ball stops (or canoes) intervening between the annular track and the roulette wheel, causing the ball to jump about. Eventually the roulette ball will come to rest in one of the numerous equally spaced ball slots located along a circumference of the roulette wheel. Each ball slot among the equally spaced ball slots is isolated from adjacent ball slots by separators positioned radially outward and corresponds to a particular number and color. The particular number represents a result for the game cycle that began when the roulette ball was launched.

As the roulette ball comes to rest, a marker (or dolly) may be used to mark a betting area (or layout) of a display or a physical horizontal surface that is separate from the roulette mechanism. The dolly identifies the particular number and color on the layout corresponding to the ball slot in which the roulette ball came to rest. Winning and losing selections for that game cycle that had been electronically or physically placed on the selection area prior to a selection close time of that game cycle are then determined according to the result. Once the losing and winning selections are resolved, a new game cycle starts.

Although roulette can be a fun and exciting on its own, there have been numerous attempts to add further fun and excitement by modifying aspects of roulette as structured in different parts of the world. Roulette systems may include a number of numbers on the number circle spaced apart and arranged in different manners. The number circles of roulette wheels typically include at least 36 numbers. Some number circles may include additional numbers and the roulette wheels may include a corresponding number of ball slots, which can change the arrangement of the numbers of the number circle. Number circles including an extra number are typically numbered “0”, two extra numbers are typically numbered “0” and “00”, etc. The zeros numbers are typically green and therefore neither even nor odd. FIG. 1 is an exemplary illustration of a prior art roulette wheel system 10, including a roulette wheel 12 that spins in one direction and is surrounded by a stationary annular track 14 within which a ball 16 is spun in the opposite direction of the roulette wheel's spin. A surface of the roulette wheel 12 slopes toward that ball slots 18, which are surrounded by the number circle 19. The number circle corresponds to a 37 number roulette system with one added “0”.

However, many visual modifications to roulette wheel systems are limited to static changes, such as permanent or semi-permanent modifications to one or more aspects of the device. This may include a color scheme change to the wheel, numbers, pockets, labels, or other areas of the roulette system. Such visual modifications may also require the game to go offline for a period of time, while the modifications are installed on the wheel. This may result in lower profitability and decreased player experience, since less roulette games are available for play. In addition, visual modifications may become outdated after a period of time and/or due to customer familiarity. This may create additional challenges and costs related to selecting visual modifications that are appealing and will generate excitement for the game over time, since any further changes would result in additional costs and servicing time.

### SUMMARY

A roulette wheel system and method of using are disclosed. A roulette wheel may include at least one rim, an optical display system positioned beneath the at least one rim, and a controller. The optical display system may include one or more LEDs or an LCD display. The optical display system is configured to provide a plurality of lighting effects visible through the at least one rim. A controller may provide signal content to the optical display system, to produce a lighting effect corresponding to current gaming information. According the various embodiments, lighting effects may include the simulation of the rotation of numbers and symbols, indicate real-time game information, track a position of a roulette ball, respond to various gaming events, and/or promote interest and excitement towards the game.

These and other features will be more clearly understood from the following detailed description taken in conjunction with the accompanying drawings and claims. This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is an illustration of a prior art roulette wheel.

FIG. 2 is a perspective view of a roulette wheel with a visual display rim in accordance with an embodiment.

FIG. 3 is a cross-sectional perspective view of a roulette wheel with a visual display rim in accordance with an embodiment.

FIG. 4 is a cross-sectional side view of a roulette wheel with a visual display rim in accordance with an embodiment.

FIG. 5 is a partial cross-section side view of a roulette wheel with a visual display element in accordance with an embodiment.

FIG. 6 is a representation of display elements in accordance with an embodiment.

FIG. 7 is a block diagram of an embodiment of a computer system.

### DETAILED DESCRIPTION OF ILLUSTRATIVE EMBODIMENTS

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

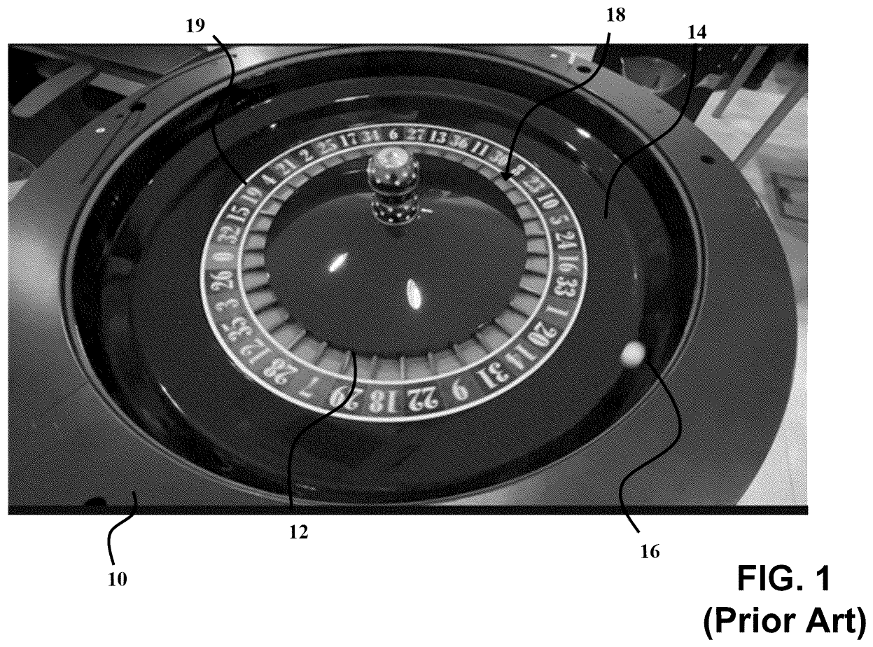

Most roulette systems or mechanisms have a base 10, a cone 12, a stationary rim 14 around which a ball 16 travels, and a rotating roulette wheel 18 positioned in the middle of the base and having pockets into which the ball 16 eventually falls. The roulette wheel includes a number of pockets configured to hold the roulette ball. A number between 0 and 36 (and also 00 on some roulette wheels) and a color (typically green for 0 and 00 and alternating between red and black for the other numbers) are assigned to each of the pockets. The stationary rim includes a single angled annular track in which a single roulette ball manually spins. At the beginning of a game cycle, typically after further selections are closed, a dealer will either manually spin the roulette ball in the track or the roulette balls will be launched from a launch tube. The roulette ball spins in the opposite direction of the rotating roulette wheel. When the roulette ball eventually exits the track, the ball will ultimately land in one of the pockets indicating the end of that game cycle. FIG. 1 is an illustration of a prior art roulette system with 37 pockets 18 and the numbers 0-36 on the number circle 19.

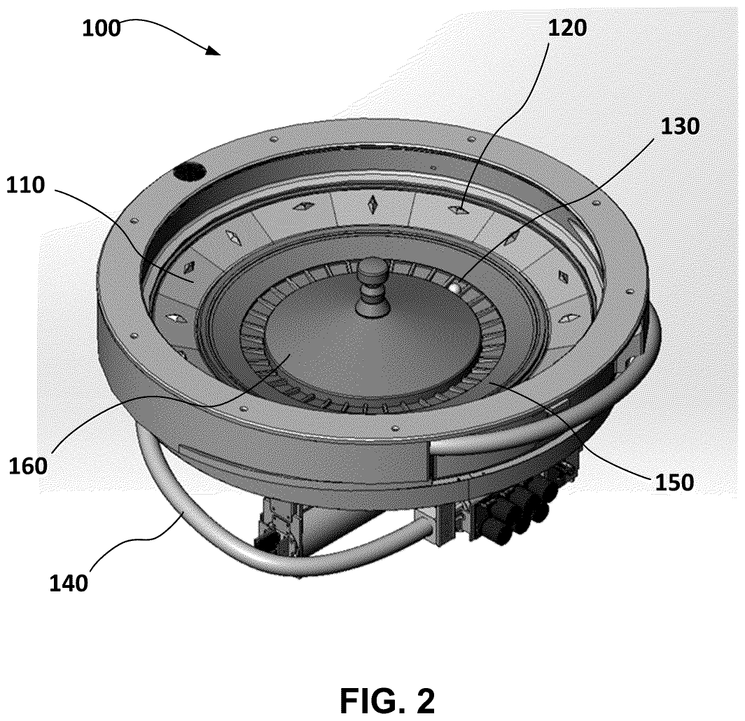

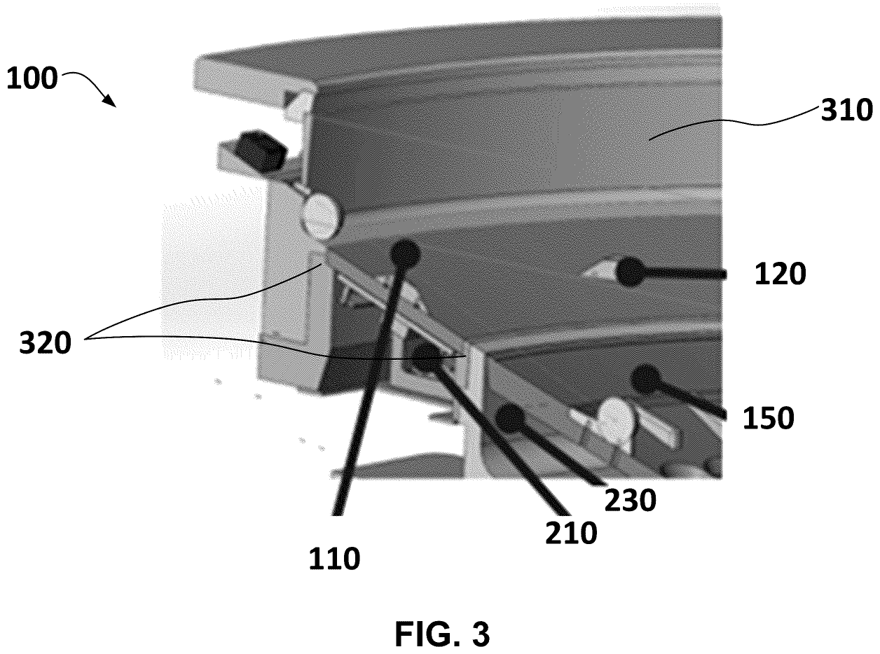

FIG. 2 illustrates a roulette wheel system including a visual display rim 110. When a roulette ball is launched from a launch tube 140, the ball travels around the rim 110, and eventually drops into a pocket (e.g., pocket 130 of the rim 110) once it loses momentum. In various embodiments, the rim 110 may be stationary, while a roulette wheel 220 (as shown in FIG. 3) spins in a direction opposite the direction of a roulette ball launch. The visual display rim 110 may include one or more raised physical elements, such as canoe 120, which may contact the roulette ball and deflect its path, causing unpredictability and increasing excitement and attention towards the gameplay. Canoes 120 may be placed in any of a variety of positions orientations around the rim 110.

The visual display rim 110 may also include the number circle and pockets, all of which may be made of a transparent or semi-transparent material of any color or combination of colors. In some embodiments, the visual display rim 110 may be glass, such as a transparent polycarbonate glass. In other embodiments the visual display may include one or more types of transparent materials, including but not limited to plastics, glass, resins, and other thermoplastic polymers and polycarbonate materials.

As best seen in FIGS. 2-5, the roulette wheel 220 may include a number circle area 150 that may be positioned between the visual display rim 110 and the pockets 130. In examples, the number circle area 150 may be provided on a top surface of the roulette wheel and be an extension of the visual display rim 110. The number circle area 150 may also be a transparent or semi-transparent material of any color or combination of colors. In some embodiments, the number circle area 150 is a glass material, such as a transparent polycarbonate glass. In other embodiments the number circle area 150 may include one or more types of transparent materials, including but not limited to plastics, glass, resins, and other thermoplastic polymers and polycarbonate materials. An optical display system 210 may be positioned beneath the visual display rim 110 as well as extend beneath the number circle area 150 and the pockets 130. The optical display system may serve to display text, numbers, icons, flashes, colors, or any of a variety and combination of lighting effects, which will be visible on or through the visual display rim 110, the number circle area 150, and the pockets 130. The optical display system 210 may include one or more light emitting diodes (LEDs). In some embodiments, the optical display system 210 includes a display, such as a liquid crystal display (LCD). A combination of various lighting elements may be applied to create a desired visual effect for the display rim 110. For example, the optical display system may include an LCD screen installed along the bottom of the rim 110, and one or more LEDs providing additional visual effects.

In embodiments, the number circle area 150 may display the numbers 0-36 as shown on the number circle 19 of FIG. 1 or some other combination of numbers and symbols. In embodiments, the number circle area 150 may rotate with the rest of the roulette wheel 220. In embodiments, the number circle area 150 may be stationary with the visual display rim 110 and the display of the optical display system 210 may simulate the numbers, such as 0-36 or some other combination of numbers and symbols, rotating like they would in FIG. 1 when the roulette wheel 220 rotates.

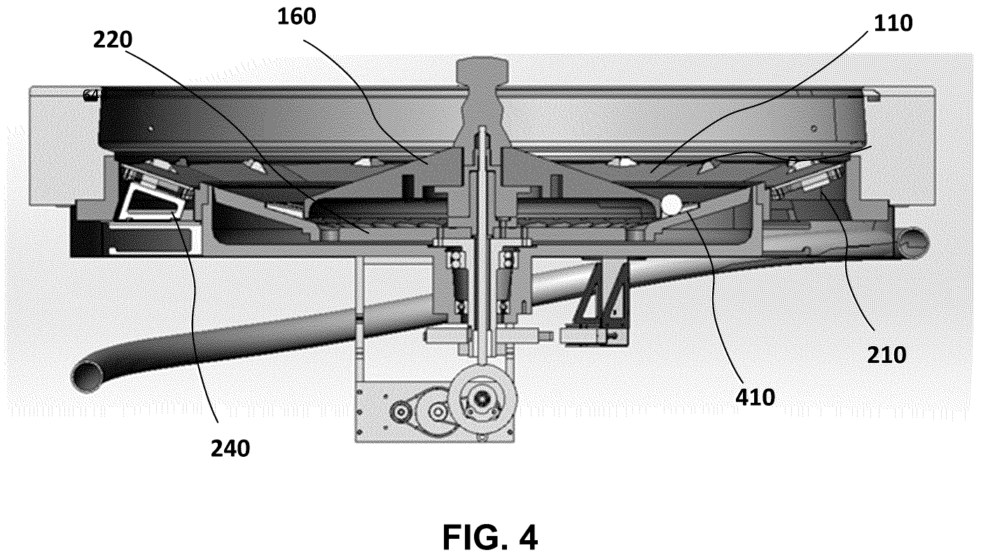

In various embodiments, the optical display system 210 may be directly attached to the bottom side of the display rim 110 and the number circle area 150. In some examples the optical display system 210 may be a removable element. In other examples, the optical display system 210 may be formed as part of the display rim 110, the number circle area 150, and pockets 130. The display rim 110 may additionally have one or more recesses, protrusions, mounts, or other physical elements to attach and/or remove the optical display system 210. For example, support bracket 240, as best seen in FIG. 4, may provide a support upon which the lighting elements 210 and/or the rim 110 may be placed. A similar support bracket 240 may be positioned beneath the number circle area 150 and/or the pockets 130.

A removable and/or interchangeable optical display system may enable efficient replacements or repairs of lighting elements, which would lead to less time that the game is offline. A variety of optical display systems may enable additional lighting display combinations, which could make a game more attractive to current and potential players.

FIGS. 3 and 4 provides an alternate view of the visual display rim 110, the number circle area 150, the pockets 130, and the roulette system 100 elements. In various embodiments, the visual display rim 110, the number circle area 150, and the pockets 130 are tilted at an angle and positioned above the rest of the roulette wheel 220. The display rim 110 may be stationary, while the roulette wheel 220 and cone 160 may spin in a direction opposite to the launch direction of the roulette ball. As noted, the number circle area 150 may also be stationary but simulate the combination of numbers and symbols rotating, or actually physically rotate with the roulette wheel and cone 160. A spacer element 230 may separate the rim 110 and wheel 220 so that that the wheel can freely rotate. The spacer element 230 may also be positioned between the pockets 130 and the number circle area 150.

In embodiments, the display rim 110, the number circle area 150 and pockets 130 may be tilted 21° above a horizontal plane of the roulette wheel. Any other tilt angle, or no tilt angle, may be used to position the display rim 110 and its components.

The visual display rim 110 and the number circle area 150 may also be removable elements, fitted into the area between the outer wall 310 and the spacer element 230. For example, the visual display rim 110 may sit in a defined groove 320 formed by one or more elements of the roulette wheel (e.g., outer wall 310, spacer element 320, etc.). The groove 320 may be extended to include the number circle area 150 and the pockets 130. This capability may introduce greater variety to the roulette gaming system. For example, different visual display rims 110 may include different colors, materials, with canoe shapes, sizes, colors, or other physical elements, and the number circle area 150 an pockets 130 could be modified in ways that may add to the excitement and visual attraction of the game.

FIG. 4 illustrates a cross-sectional side view of the roulette gaming system. In various embodiments, the lighting effects may be controlled via a controller, which may be local to the roulette gaming system or remotely located. A controller may allow game operators to manually change one or more lighting effects or routines, as desired. The controller may also provide pre-programmed routines and effects, which may be selected, or automatically occur when certain roulette wheel events occur, and/or if certain sensors are triggered. Sensors may include, but are not limited to, an optic sensor, proximity sensor, force sensor, pressure sensor, and position sensor.

The controller may communicate with one or more sensors and devices to control a lighting sequence or visual effect. As discussed herein, a sensor may indicate a current status or the game, a position of the roulette ball (e.g., within a launch tube 140, within a pocket 130), contact with a gaming element, such as canoe 120, or any other aspect of the roulette gaming system. For example, a sensor may provide real-time feedback to the controller, e.g., related to a position of the roulette ball, and lighting sequences may correspond to the real-time feedback, e.g., tracking, highlighting, or otherwise indicating a position of the roulette ball.

In an example, a first lighting sequence may occur while the roulette ball is spinning within the track of the wheel, a second lighting sequence may occur when the roulette ball leaves the track, and a third lighting sequence may occur when the ball has landed within a pocket 130. A sensor, e.g., sensor 410, may be an optic sensor, which may identify a presence of a ball in the track and within a particular pocket so as to trigger the different lighting sequences, i.e., the first lighting sequence when the ball is sensed in the track, the second lighting sequence when the ball is no longer sensed in the track but not yet sensed in a pocket, and the third lighting sequence when the ball is sensed in a pocket.

The visual display rim 110 and optical display system may highlight an arrow, number, identifier, or other lighting effect to indicate the pocket with the roulette ball. In another example, when a sensor (e.g., pressure, force, position, etc.) indicates contact of the roulette ball with a canoe 120, a lighting effect may be triggered, such as highlighting the canoe, or other visual or color effect on the display rim. To further enhance the roulette mechanism and make it easier for players to identify the pocket in which a roulette ball has landed lighting could be provided to light up the pocket sensed to contain the ball. Again, the lighting could be triggered by a sensor 410 detecting the roulette ball in or not in different locations, such as a pocket.

In some embodiments, the optical display system 210 may display information, such as player information, gaming information, a current score, current winnings, a bet, number of players, a date, time, name, game type, winning numbers, winning bets, and the like. In some examples, the optical display system may cause the visual display rim 110 and/or the number circle area 150 and/or pockets 130 to be a certain color or combination of colors for a period of time. In various embodiments, sound effects may accompany one or more visual displays provided on the visual display rim 110, the number circle area 150, and the pockets 130.

The lighting elements of the visual display rim, the number circle area 150, and the pockets 130 may be programmed to automatically run through a lighting sequence(s) and/or produce certain lighting effects when an event occurs during the operation of the roulette system. For example, certain lighting combinations may occur when there is not an active game being played. Flashing lights and colors may be used to attract players to the game. During gameplay, the system may show a current player name and other player or gaming information. Certain lighting and/or sound effects may enhance gameplay, or keep the player's attention, for example. Additional enhancement features include the ability to shine light through one or more crystals embedded in the visual display rim 110, a canoe 120, or other rim element or the number circle area 150 or pockets 130 during a game or when a roulette ball lands in a pocket, such as by highlighting the corresponding number or symbol within the number circle area 150 or shining a light through the pocket so to further indicate the outcome of each game or for some other reason.

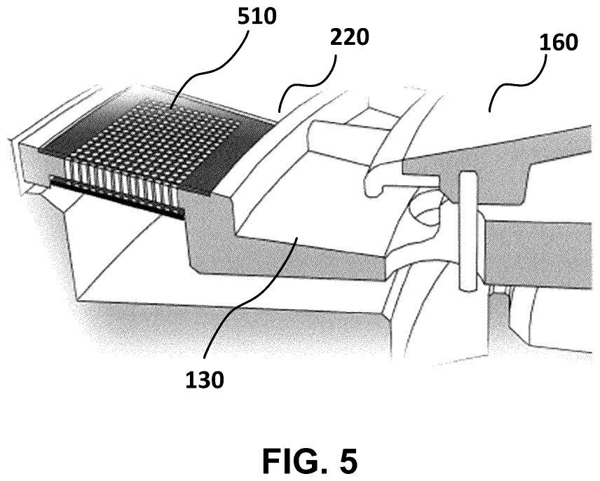

FIG. 5 illustrates a partial cross-sectional side view of a rotatable roulette wheel having a plurality of light sources 510 positioned along the number circle area 150. The light sources 510 may include one or more LEDs forming an array at each pocket 130. The light sources may be a part of the optical display system 210 discussed herein, and include a display, such as a liquid crystal display (LCD), or other light projection device. In other examples, the light sources are part of one or more LED arrays positioned to be viewable along a perimeter of the plurality of pockets on the roulette wheel, e.g., number circle area 150.

Light sources 510 may be provided at each pocket 130 to provide gaming information, such as pocket labels, numbers (e.g., 0, 00, 1-37, etc.), and bonus information. The lighting sources may change before, during, and after gaming events, to convey different gaming information throughout a gaming cycle. Such gaming information may include identifying a winning pocket, a bonus associated with one or more pockets, and any numbers having an associated bet.

A sequence of lighting effects may be generated throughout a game cycle. For example, a first set of lighting effects, such as gameplay rules, betting information and bonuses, bet types, numbers, and symbols may be provided during a betting period. A second set of lighting effects, for example, pocket number labels, may be provided after the betting period closes and throughout the roulette ball launch and wheel spin cycle. A third set of lighting effects, such as a winning number, may be provided after a roulette ball comes to rest in a pocket and a winning number and/or other bets are determined. Embodiments may include variations to communicate one or more of a roulette ball position, a number, a symbol, a color, a bonus, a winning outcome, and an animation.

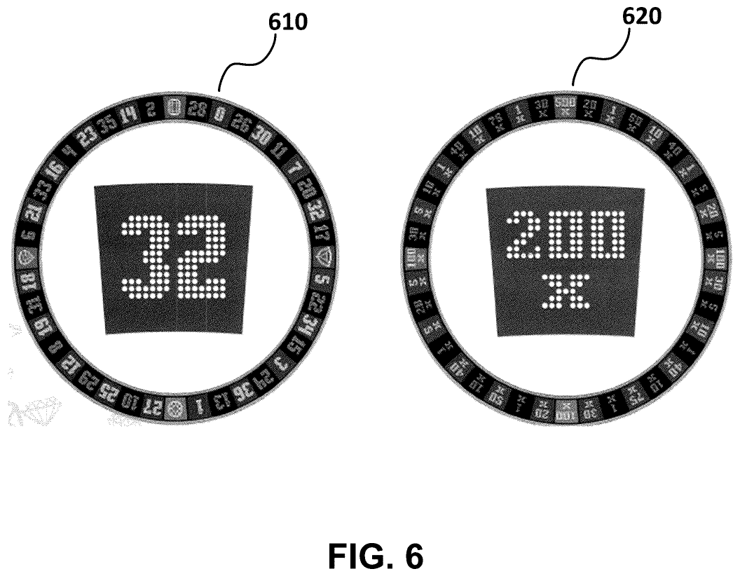

FIG. 6 illustrates two examples with lighting elements along the rotatable rim, to label the number circle area 150. In both examples, lighting effects are also provided on the cone 160 covering a central portion of the rotatable roulette wheel. Such lighting effects may be provided based on signal content from the controller. The signal content, as described herein, may represent gaming information, which may include at least one of: a roulette ball position, a game timing, a roulette ball launch, and a gaming outcome. The lighting effects on the cone 160 may be generated using any of the plurality of lighting techniques and lighting elements discussed herein.

At wheel 610, the number wheel area 150 provides labeling information to convey symbols associated with each pocket. The lighting sources 510 show standard roulette wheel numbers and other symbols, such as a diamond, which may indicate a bonus and otherwise correspond with a bet option at an associated betting area. The central number, e.g., on the cone 160, may indicate a past or current winning number or symbol, for example, “32”. At wheel 620, light sources in the number wheel area 150 indicate a bonus, e.g., 1×-500×, associated with each pocket. The lighting display on the cone 160 may indicate a past, current, or upcoming bonus amount, such as “200×” . . .

In some examples, the lighting sources may alternate between displaying pocket numbers and associated bonuses. The lighting sources 510 may also provide various lighting effects (e.g., colors, symbols, animations, brightness, etc.) to provide a source of attraction and keep players attentive to the present game. Such features may also help communicate game rules, bonus play information, and the like, to assist new players and introduce new gaming features. These lighting features may be provided along with other lighting effects and animations on the stationary rim, as previously discussed herein. The optical display system may generate lighting effects on the stationary rim (e.g., a transparent, stationary rim) sequentially, alternately, and/or concurrently with any lighting effects on the rotatable roulette wheel and the cone.

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

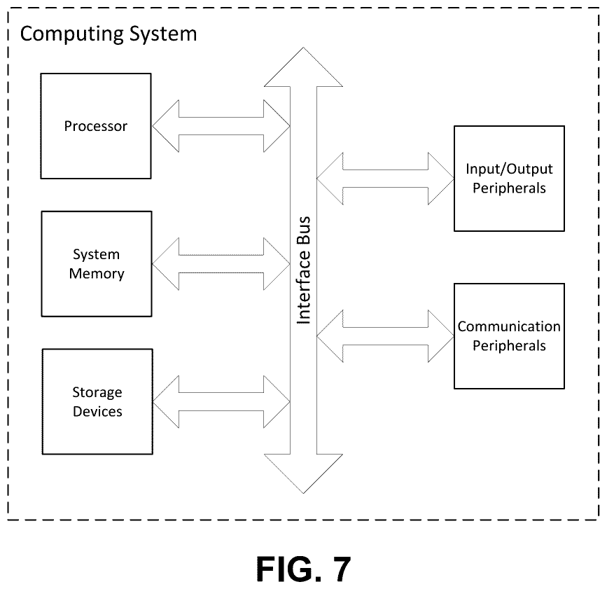

Some of the techniques described above can be implemented on a computing device associated with a gaming device (e.g., a roulette mechanism), a plurality of computing devices associated with a plurality of gaming devices, a controller in communication with the gaming device(s) (e.g., a controller configured to synchronize the gaming devices(s)), or a plurality of controllers in communication with the gaming device(s). Additionally, some of the techniques may be distributed between the computing device(s) and the controller(s). FIG. 7 illustrates an exemplary block diagram of a computing system that includes hardware modules, software module, and a combination thereof and that can be implemented as the computing device and/or as the server.

In a basic configuration, the computing system may include at least a processor, a system memory, a storage device, input/output peripherals, communication peripherals, and an interface bus. Instructions stored in the memory may be executed by the processor to perform a variety of methods and operations, including the shooter selection and console mirroring, as described above. The computing system components may be present in the gaming device, in a server or other component of a network, or distributed between some combinations of such devices.

The interface bus is configured to communicate, transmit, and transfer data, controls, and commands between the various components of the electronic device. The system memory and the storage device comprise computer readable storage media, such as RAM, ROM, EEPROM, hard-drives, CD-ROMs, optical storage devices, magnetic storage devices, flash memory, and other tangible storage media. Any of such computer readable storage medium can be configured to store instructions or program codes embodying aspects of the disclosure. Additionally, the system memory comprises an operation system and applications. The processor is configured to execute the stored instructions and can comprise, for example, a logical processing unit, a microprocessor, a digital signal processor, and the like.

The system memory and the storage device may also comprise computer readable signal media. A computer readable signal medium may include a propagated data signal with computer readable program code embodied therein. Such a propagated signal may take any of variety of forms including, but not limited to, electro-magnetic, optical, or any combination thereof. A computer readable signal medium may be any computer readable medium that is not a computer readable storage medium and that can communicate, propagate, or transport a program for use in connection with the computing system.

Further, the input and output peripherals include user interfaces such as a keyboard, screen, microphone, speaker, other input/output devices, and computing components such as digital-to-analog and analog-to-digital converters, graphical processing units, serial ports, parallel ports, and universal serial bus. The input/output peripherals may also include a variety of sensors, such as light, proximity, GPS, magnetic field, altitude, and velocity/acceleration. RSSI, and distance sensors, as well as other types of sensors. The input/output peripherals may be connected to the processor through any of the ports coupled to the interface bus.

The user interfaces can be configured to allow a user of the computing system to interact with the computing system. For example, the computing system may include instructions that, when executed, cause the computing system to generate a user interface and carry out other methods and operations that the user can use to provide input to the computing system and to receive an output from the computing system.

This user interface may be in the form of a graphical user interface that is rendered at the screen and that is coupled with audio transmitted on the speaker and microphone and input received at the keyboard. In an embodiment, the user interface can be locally generated at the computing system. In another embodiment, the user interface may be hosted on a remote computing system and rendered at the computing system. For example, the server may generate the user interface and may transmit information related thereto to the computing device that, in turn, renders the user interface to the user. The computing device may for example, execute a browser or an application that exposes an application program interface (API) at the server to access the user interface hosted on the server.

Finally, the communication peripherals of the computing system are configured to facilitate communication between the computing system and other computing systems (e.g., between the computing device and the server) over a communications network. The communication peripherals include, for example, a network interface controller, modem, various modulators/demodulators and encoders/decoders, wireless and wired interface cards, antenna, and the like.

The communication network includes a network of any type that is suitable for providing communications between the computing device and the server and may comprise a combination of discrete networks which may use different technologies. For example, the communications network includes a cellular network, a WiFi/broadband network, a local area network (LAN), a wide area network (WAN), a telephony network, a fiber-optic network, or combinations thereof. In an example embodiment, the communication network includes the Internet and any networks adapted to communicate with the Internet. The communications network may be also configured as a means for transmitting data between the computing device and the server.

The techniques described above may be embodied in, and fully or partially automated by, code modules executed by one or more computers or computer processors. The code modules may be stored on any type of non-transitory computer-readable medium or computer storage device, such as hard drives, solid state memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

In an embodiment, a roulette wheel system may include a transparent rim positioned above and sloping downwards towards a rotatable roulette wheel, an optical display system positioned beneath the transparent rim, the optical display system configured to provide a plurality of lighting effects visible through the transparent rim, and a controller providing signal content to the optical display system, wherein the signal content produces at least a first lighting effect corresponding to current gameplay information.

In another embodiment, a sensor may provide real-tie feedback to the controller, the feedback being indicative of a roulette ball position. In another embodiment, the first lighting effect may indicate the roulette ball position. The sensor may include at least one of an at least one of an optical sensor, a proximity sensor, a pressure sensor, and a position sensor.

In another embodiment, the optical display system comprises a liquid crystal display.

In another embodiment, the optical display system comprises at least one light emitting diode (LED).

In another embodiment, the transparent rim comprises polycarbonate glass.

In another embodiment, the first lighting effect comprises at least one letter, number, icon, flash, or color.

In another embodiment, gameplay information includes one or more of a roulette ball position, a bet, a date, a time, a player name, a game type, or a winning number.

In another embodiment, the transparent rim may be positioned beneath a roulette ball launch point, and a top surface of the transparent rim comprises a plurality of raised physical elements to interact with the roulette ball.

In another embodiment, the transparent rim tilted at an angle above a horizontal plane of the roulette wheel. The angle of the transparent rim is 21°.

In an embodiment, a method may comprise: receiving current gameplay information from at least one sensor associated with a roulette wheel system, determining, by a controller, a lighting effect responsive to the gameplay information, and projecting the lighting effect through a transparent rim positioned above and sloping downwards towards a rotatable roulette wheel, wherein the lighting effect is provided by an optical display system positioned beneath the transparent rim.

In another embodiment, the lighting effect communicates at least one of a roulette ball position, a bet, a date, a time, a player name, a game type, or a winning number.

In another embodiment, the sensor provides real-time gameplay information indicative of a roulette ball position, and the lighting effect tracks the roulette ball position.

In another embodiment, wherein the sensor is at least one of an optical sensor, a proximity sensor, a pressure sensor, and a position sensor. The controller may be programmed to cause the optical display system to project a first lighting sequence in response to a gaming event. In another embodiment, the gaming event is at least one of: a ball launch, a ball contact with a gaming element, a final position.

In an embodiment, a roulette wheel system, comprises: a roulette wheel comprising a rotatable rim and a plurality of pockets; an optical display system comprising a plurality of lighting elements configured to provide a lighting effect visible on a top surface of the rotatable rim; and a controller providing signal content to the optical display system, the signal content producing at least a first lighting effect corresponding to gaming information.

In another embodiment, wherein the first lighting effect communicates at least one of a roulette ball position, a number, a symbol, a color, a bonus, a winning outcome, and an animation.

In another embodiment, wherein the optical display system comprises at least one of: an LED array, a projection device, and a liquid crystal display.

In another embodiment, wherein the first lighting effect produces visible symbols along a perimeter of the plurality of pockets.

In another embodiment, further comprising a stationary rim positioned above and sloping downwards towards the roulette wheel, wherein the optical display system provides a second lighting effect visible on a top surface of the stationary rim.

In another embodiment, wherein the stationary rim is transparent, and the optical display system generates the second lighting effect through the stationary rim using a second plurality of lighting elements.

In another embodiment, wherein the stationary rim is positioned beneath a roulette ball launch point and is tilted at an angle above a horizontal plane of the roulette wheel.

In another embodiment, further comprising a cone covering a central portion of the roulette wheel, and wherein the optical display system produces, based on the signal content from the controller, a third lighting effect.

In another embodiment, wherein the third lighting effect shows at least one of a pocket symbol, a winning amount, and a bonus value.

In an embodiment, a method, comprises: receiving gaming information from at least one sensor associated with a roulette wheel system, the roulette wheel system comprising a plurality of pockets and a rotatable rim along a perimeter of the plurality of pockets; determining, by a controller, a first lighting effect responsive to the gaming information; and producing, by an optical display system, the lighting effect on a top surface of the rotatable rim

In another embodiment, wherein the optical display system comprises a plurality of lighting elements, and at least one set of lighting elements corresponding to a pocket.

In another embodiment, wherein the lighting effect displays at least one of a roulette ball position, a number, a symbol, a color, a bonus, a winning outcome, and an animation.

In another embodiment, further comprising: generating a sequence of lighting effects throughout a game cycle.

In another embodiment, further comprising producing, by the optical display system, a second lighting effect on a cone covering a central portion of the roulette wheel system.

In another embodiment, further comprising receiving the gaming information in real-time from the at least one sensor comprising at least one of an optical sensor, a proximity sensor, a pressure sensor, and a position sensor.

In another embodiment, wherein the gaming information is indicative of at least one of: a roulette ball position, a game timing, a roulette ball launch, and a gaming outcome.

In another embodiment, further comprising generating a third lighting effect on a top surface of a stationary rim positioned above and sloping downwards towards the roulette wheel.

In another embodiment, wherein the stationary rim is transparent.

In another embodiment, wherein the optical display system generates the first lighting effect using at least one of: an LED array, a projection device, and a liquid crystal display.

In another embodiment, wherein the optical display system is positioned beneath the rotatable rim.

As previously noted, the various features and processes described above may be used independently of one another or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

The terms and descriptions used above are set forth by way of illustration only and are not meant as limitations. Those skilled in the art will recognize that those and many other variations, enhancements and modifications of the concepts described herein are possible without departing from the underlying principles of the invention. The scope of the invention should therefore be determined only by the following claims and their equivalents.

What is claimed:

1. A roulette wheel system, comprising:
a roulette wheel comprising a rotatable rim and a plurality of pockets;
an optical display system comprising a plurality of lighting elements configured to provide a lighting effect visible on a top surface of the rotatable rim; and
a controller providing signal content to the optical display system, the signal content producing at least a first lighting effect corresponding to gaming information.

2. The roulette wheel system of claim 1, wherein the first lighting effect communicates at least one of a roulette ball position, a number, a symbol, a color, a bonus, a winning outcome, and an animation.

3. The roulette wheel system of claim 1, wherein the optical display system comprises at least one of: an LED array, a projection device, and a liquid crystal display.

4. The roulette wheel system of claim 1, wherein the first lighting effect produces visible symbols along a perimeter of the plurality of pockets.

5. The roulette wheel system of claim 1, further comprising a stationary rim positioned above and sloping downwards towards the roulette wheel, wherein the optical display system provides a second lighting effect visible on a top surface of the stationary rim.

6. The roulette wheel system of claim 5, wherein the stationary rim is transparent, and the optical display system generates the second lighting effect through the stationary rim using a second plurality of lighting elements.

7. The roulette wheel system of claim 6, wherein the stationary rim is positioned beneath a roulette ball launch point and is tilted at an angle above a horizontal plane of the roulette wheel.

8. The roulette wheel system of claim 1, further comprising a cone covering a central portion of the roulette wheel, and wherein the optical display system produces, based on the signal content from the controller, a third lighting effect.

9. The roulette wheel system of claim 1, wherein the third lighting effect shows at least one of a pocket symbol, a winning amount, and a bonus value.

10. A method, comprising:
receiving gaming information from at least one sensor associated with a roulette wheel system, the roulette wheel system comprising a plurality of pockets and a rotatable rim along a perimeter of the plurality of pockets;
determining, by a controller, a first lighting effect responsive to the gaming information; and
producing, by an optical display system, the lighting effect on a top surface of the rotatable rim.

11. The method of claim 10, wherein the optical display system comprises a plurality of lighting elements, and at least one set of lighting elements corresponding to a pocket.

12. The method of claim 10, wherein the lighting effect displays at least one of a roulette ball position, a number, a symbol, a color, a bonus, a winning outcome, and an animation.

13. The method of claim 10, further comprising: generating a sequence of lighting effects throughout a game cycle.

14. The method of claim 10, further comprising producing, by the optical display system, a second lighting effect on a cone covering a central portion of the roulette wheel system.

15. The method of claim 10, further comprising receiving the gaming information in real-time from the at least one sensor comprising at least one of an optical sensor, a proximity sensor, a pressure sensor, and a position sensor.

16. The method of claim 15, wherein the gaming information is indicative of at least one of: a roulette ball position, a game timing, a roulette ball launch, and a gaming outcome.

17. The method of claim 15, further comprising generating a third lighting effect on a top surface of a stationary rim positioned above and sloping downwards towards the roulette wheel.

18. The method of claim 17, wherein the stationary rim is transparent.

19. The method of claim 15, wherein the optical display system generates the first lighting effect using at least one of: an LED array, a projection device, and a liquid crystal display.

20. The method of claim 10, wherein the optical display system is positioned beneath the rotatable rim.
